(19) United States
(12) Patent Application Publication
(10) Pub. No.: US 2006/0210072 A1
(43) Pub. Date: Sep. 21, 2006

(54) Electronic apparatus, information managing method and information managing program

(76) Inventor: Takahiko Uno, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/350,902

(22) Filed: Feb. 10, 2006

(30) Foreign Application Priority Data
Feb. 17, 2005 (JP) 2005-041100
Feb. 7, 2006 (JP) 2006-030290

(51) Int. Cl. H04L 9/00

(52) U.S. Cl. 380/44

(57) ABSTRACT

An electronic apparatus for managing first information sharable by a plurality of users, includes: an enciphering/deciphering part generating a key for enciphering and deciphering the first information for each of operational scope of the first information, with at least one combination of second information previously set for the own apparatus as a seed, and enciphering and deciphering the first information with the key.

### BACKGROUND OF THE INVENTION

1. Field of the Invention

The present invention relates to an electronic apparatus, an information managing method and an information managing program, and, in particular, to an electronic apparatus, an information managing method and an information managing program, for enciphering and deciphering information with the use of a key generated from a seed.

2. Description of the Related Art

Recently, security management for personal information managed by a user, such as user information, an address book or such, has become important. For example, personal information held in a general purpose device such as a hard disk drive is enciphered and managed. A seed for generating a key for enciphering (simply referred to as an ‘enciphering key’ hereinafter) is set in each of electronic apparatuses enciphering and managing personal information. The electronic apparatus generates the enciphering key from the seed, converts personal information with the use of the enciphering key into different data, and thus, increasing the security level.

An electronic apparatus in the related art has a function of backing up an address book in a lump, and restoring the same upon a recovery from a breakage or replacement of storage. In such an electronic apparatus, the security level may be increased as a result of the address book being enciphered. Such a backing up/restoring function may also be used for a case where a common address book is replicated, and then, is registered in a plurality of electronic apparatuses. Japanese Laid-open Patent Applications Nos. 2004-30315 and 2004-152262 disclose examples of increasing a security level.

### SUMMARY OF THE INVENTION

The same as for a password, the seed applied for generating the enciphering key for user information or an address book may be forgotten by a user, or, the user may erroneously input the seed in the electronic apparatus. Therefore, actually, to set different seeds in respective apparatuses by a user may be difficult, in a managing viewpoint. However, in a case where the user sets a single common seed for all the electronic apparatuses because the user wishes to become free from a troublesome of setting a different seed for each apparatus, respective sets of personal information stored in the respective electronic apparatuses may be leaked at once and used for a bad purpose merely if the single common seed is known by a third person by accident.

The present invention has been devised in consideration of the above-mentioned problem, and an object of the present invention is to provide an electronic apparatus, an information managing method and an information managing program, by which a key for enciphering and deciphering information can be easily generated, while a security level can be increased.

According to the present invention, an electronic apparatus managing first information sharable among a plurality of users, includes an enciphering/deciphering part generating a key for enciphering and deciphering the first information for each of operational scopes of the first information, with at least one combination of second information previously set in the own apparatus as a seed, and enciphering and deciphering the first information with said key.

The enciphering/deciphering part may allow a user to specify the operational scope of the first information, and encipher the first information with the use of said key corresponding to said operational scope; and when deciphering the thus-enciphered first information, it may try deciphering with the key corresponding to each of the operational scopes of the first information in sequence, and set the operational scope of the first information for which the deciphering is thus succeeded in, for the key with which the deciphering is thus succeeded in.

The enciphering/deciphering part may generate the key with a combination of information, unique to the apparatus, which the user cannot change, and information, which the user can change, as a seed.

The information, unique to the apparatus, which the user cannot change, may be made of information concerning a manufacturer or a selling agency of the electronic apparatus and information uniquely identifying the apparatus.

The information, unique to the apparatus, which the user cannot change, may be made of a manufacturer name, a model name and a serial number.

The information which the user can change may include company information, division information and manager information.

The operational scope of the first information may include a scope only for the apparatus alone, a scope only for each manager, a scope common within a company, and a scope common within a division.

The first information may be address-book information.

The enciphering/deciphering part may allow a user to specify the operational scope of the first information, enciphers the first information with the key corresponding to the operational scope of the first information, and back up the first information;

may decipher with the key corresponding to the operational scope of the first information, and restore the first information in the electronic apparatus within the operational scope.

Further, according to the present invention, an information managing method for managing first information sharable by a plurality of users, includes: key generating step of generating a key for enciphering and deciphering the first information for each of operational scopes of the first information, with at least one combination of second information previously set in the own apparatus as a seed; and an enciphering/deciphering step of enciphering and deciphering the first information with the key.

The enciphering/deciphering step may include an enciphering step of allowing a user to specify the operational scope of the first information, and enciphering the first information with the use of the key corresponding to the operational scope; a deciphering step of deciphering the thus-enciphered first information, by trying to decipher with the key corresponding to each of the operational scopes of the first information in sequence; and setting the operational scope of the first information for which the deciphering is thus succeeded in, for the key with which the deciphering is thus succeeded in.

The enciphering/deciphering step may generate the key with a combination of information, unique to the apparatus, which the user cannot change, and information, which the user can change, as a seed.

The information, unique to the apparatus, which the user cannot change, may include information concerning a manufacturer or a selling agency of the electronic apparatus and information uniquely identifying the apparatus.

The information, unique to the apparatus, which the user cannot change, may include a manufacturer name, a model name and a serial number.

The information which the user can change may include company information, division information and manager information.

The operational scope of the first information may be a scope only for the apparatus itself, a scope only for each manager, a scope common within a company, and a scope common within a division.

The first information may be address-book information.

The enciphering/deciphering step may include: a backing up step of allowing a user to specify the operational scope of the first information, enciphering the first information with the key corresponding to the operational scope of the first information, and backing up the first information; a restoring step of deciphering with the key corresponding to the operational scope of the first information, and restoring the first information in the electronic apparatus within the operational scope.

According to the present invention, in an information managing program executed by an electronic apparatus, configured to include a storage and a processing unit, which manages first information sharable by a plurality of users, the storage storing the first information and second information previously set in the electronic apparatus; and the processing unit executing: a key generating step of generating a key for enciphering and deciphering the first information for each of operational scopes of the first information, with at least one combination of second information previously set in the own apparatus as a seed; and an enciphering/deciphering step of enciphering and deciphering the first information with the key.

The enciphering/deciphering step may include an enciphering step of allowing a user to specify the operational scope of the first information, and enciphering the first information with the use of the key corresponding to the operational scope; a deciphering step of deciphering the thus-enciphered first information, by trying to decipher with the key corresponding to each of the operational scopes of the first information in sequence; and setting the operational scope of the first information for which the deciphering is thus succeeded in, for the key with which the deciphering is thus succeeded in.

In the electronic apparatus according to the present invention, a key for enciphering and deciphering the first information is generated for each of operational scopes of the first information, with at least one combination of second information previously set in the own apparatus as a seed, and enciphering and deciphering the first information with the key.

As a result, management of the key is not required, and also, the key which is not fixed but variable can be easily generated for each operational scope of the first information. Accordingly, a security level is increased.

Further, in the electronic apparatus according to the present invention, the operational scope of the first information may be specified by a user, and the first information may be enciphered with the use of the key corresponding to the operational scope; and, upon deciphering of the thus-enciphered first information, deciphering may be tried with the key corresponding to each of the operational scopes of the first information in sequence, and the operational scope of the first information for which the deciphering is thus succeeded in may be set for the key with which the deciphering is thus succeeded in.

As a result, the operational scope for which deciphering is succeeded in can be easily set.

Further, in the electronic apparatus according to the present invention, the key may be generated, with a combination of information, unique to the apparatus, which the user cannot change, and information, which the user can change, as a seed.

Thus, the key corresponding to the operational scope of the first information can be generated.

Further, in the electronic apparatus according to the present invention, the information, unique to the apparatus, which the user cannot change, may be made of information concerning a manufacturer or a selling agency of the electronic apparatus and information uniquely identifying the apparatus.

As a result, the enciphered first information can be shared among the apparatuses belonging to the predetermined operational scope.

Further, in the electronic apparatus according to the present invention, the information, unique to the apparatus, which the user cannot change, may be made of a manufacturer name, a model name and a serial number.

Further, in the electronic apparatus according to the present invention, the information which the user can change may include company information, division information and manager information.

As a result, a variation of the operational scope of allowing the first information to be shared can be made to correspond to the actual user's environment, organization or such.

Further, in the electronic apparatus according to the present invention, the operational scope of the first information may be a scope only for the apparatus itself, a scope only for each manager, a scope common within a company, and a scope common within a division.

Further, in the electronic apparatus according to the present invention, the first information may be address-book information.

Further, in the electronic apparatus according to the present invention, the enciphering/deciphering part may allow a user to specify the operational scope of the first information, encipher the first information with the key corresponding to the operational scope of the first information, and back up the first information; may decipher with the key corresponding to the operational scope of the first information, and restore the first information in the electronic apparatus belonging to the operational scope.

A method, an apparatus, a system, a computer program, an information recording medium, a data structure and so forth, which apply elements, expressions, or any combinations of elements of the present invention, may correspond to respective modes of the present invention.

According to the present invention, an electronic apparatus, an information managing method and an information managing program may be provided, by which a key for enciphering and deciphering information can be easily generated, while a security level can be increased.

### BRIEF DESCRIPTION OF THE DRAWINGS

Other objects and further features of the present invention will become more apparent from the following detailed description when read in conjunction with the accompanying drawings:

FIG. 1 shows a configuration diagram of one embodiment of the entirety of a copier;

FIG. 2 shows a control block diagram of one embodiment of the entire system of the copier;

FIG. 3 shows a configuration diagram of one example of an operation part;

FIG. 4 shows a page image diagram in one example displayed on a liquid crystal touch panel;

FIG. 5 shows a page image diagram in one example displayed on the liquid crystal touch panel when an initial set key is pressed;

FIG. 6 shows a page image diagram in one example of installation/managing information setting page;

FIG. 7 shows a page image diagram in one example of an address book backing up page;

FIG. 8 shows a configuration diagram in one example of an enciphering program;

FIG. 9 shows a flow chart in one example of an address book backing up processing;

FIG. 10 shows a configuration diagram in one example of a seed set for each operational scope of the address book;

FIG. 11 shows a page image diagram in one example indicating a result page obtained when the address book backing up processing ended in success;

FIG. 12 shows a page image diagram in one example indicating a result page obtained when the address book backing up processing ended in failure;

FIG. 13 shows a page image diagram in one example of an address book restoration page;

FIG. 14 shows a flow chart in one example of an address book restoration processing;

FIG. 15 shows a page image diagram in one example of a result page indicating that the address book restoration processing is failed in;

FIG. 16 shows a page image diagram in one example of a result page indicating that the address book restoration processing is succeeded in;

FIG. 17 shows a schematic diagram of relationship between the operational scopes of address book to back up, and apparatuses in which restoration can be made; and

FIG. 18 shows a configuration diagram of one embodiment of a PC executing an enciphering program.

### DETAILED DESCRIPTION OF THE PREFERRED EMBODIMENTS

A best mode for carrying out the present invention will now be described with reference to figures. For an embodiment of the present invention, description is made below for a digital copier (simply referred to as a ‘copier’, hereinafter) is applied as one example of an electronic apparatus. However, an electronic apparatus according to the present invention may be instead any other type of an electronic apparatus.

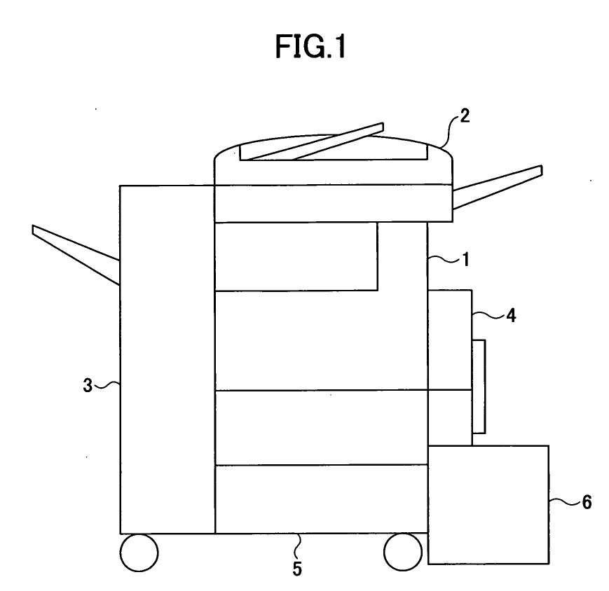

FIG. 1 shows a configuration diagram of one embodiment of the entirety of a copier. The copier in FIG. 1 includes six units, i.e., a copier body 1, an automatic document feeding unit (refereed to as an ADF, hereinafter) 2, a stapler and finisher 3 having a function of ejecting a large amount of paper sheets on which images have been formed, a both side inverting unit 4, an extended paper feeding tray 5 and a large-amount paper feeding tray 6. The copier body 1 includes a scanner part, a writing part, a photosensitive body part, a developing part, a paper feeding part and so forth.

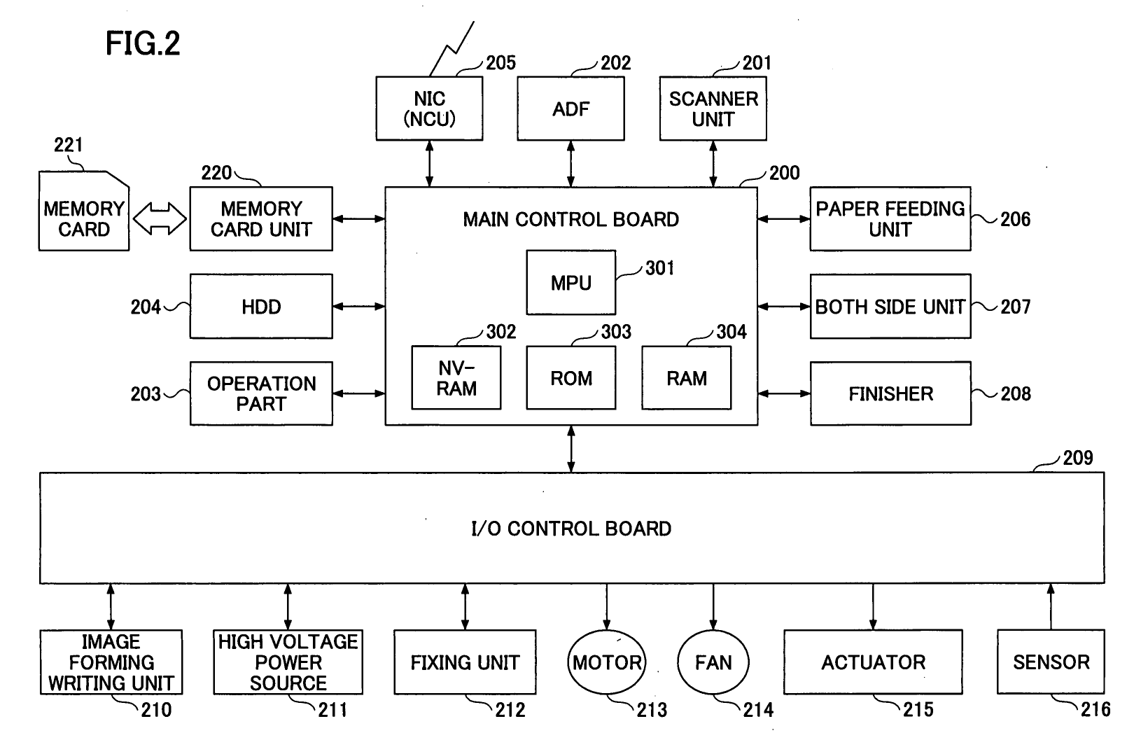

FIG. 2 shows a control block diagram of one embodiment of the entire system of the copier. The copier system shown in FIG. 2 includes a main control board 200, a scanner unit 201, an ADF 202, an operation part 203, a hard disk drive (referred as an HDD, hereinafter) 204, a network controller (referred to as a an NIC, hereinafter) 205, a paper feeding unit 206, a both side unit 207, a finisher 208, an I/O control board 209, an image forming writing unit 210, a high voltage power source 211, a fixing unit 212, a motor 213, a fan 214, an actuator 215, a sensor 216, and a memory card unit 220.

The main control board 200 includes an MPU (micro processing unit) 301 as a center of control, an NV-RAM (non volatile RAM) 302, a ROM (read only memory) 303 and a RAM (random access memory) 304.

To the main control board 200, the scanner unit 201, the ADF 202, the operating part 203, the HDD 208, the NIC 205, the paper feeding unit 206, the both side unit 207, the finisher 208 and the memory card unit 220 are connected. Via a special control LSI, each thereof carries out data transmission/reception, or data reading/writing, with the use of a controller board, not shown.

The I/O control board 209 is connected with the main control board 200 by a bus. To the I/O control board 209, the image forming writing unit 210, the high voltage power source 211, the fixing unit 212, the motor 213, the fan 214, the actuator 205 and the sensor 216 are connected.

The motor 213, the fan 214 and the actuator 215 are driven by output signals of the main control board 200 via the I/O control board 209. The sensor 216 transmits an input signal to the main control board 200 via the I/O control board 209. The image forming writing unit 210, the high voltage power source 211 and the fixing unit 212, for forming an image from image data, are controlled by the main control board 200 via the I/O control board 209.

In the HDD 204, user information, i.e., a so-called address book, is stored, which may be used by a facsimile application or scanner application function. To/from the memory card unit 220, a memory card 221 may be inserted or removed. When the memory card 221 is inserted in the memory card unit 220, the main control board 200 can write data to/read data from the memory card 221.

In the ROM 204, an enciphering program for enciphering/deciphering data is stored. The enciphering program is one example of an information managing program according to the present invention. In an enciphering algorithm in the enciphering program, an enciphering key having a predetermined data length can be designated.

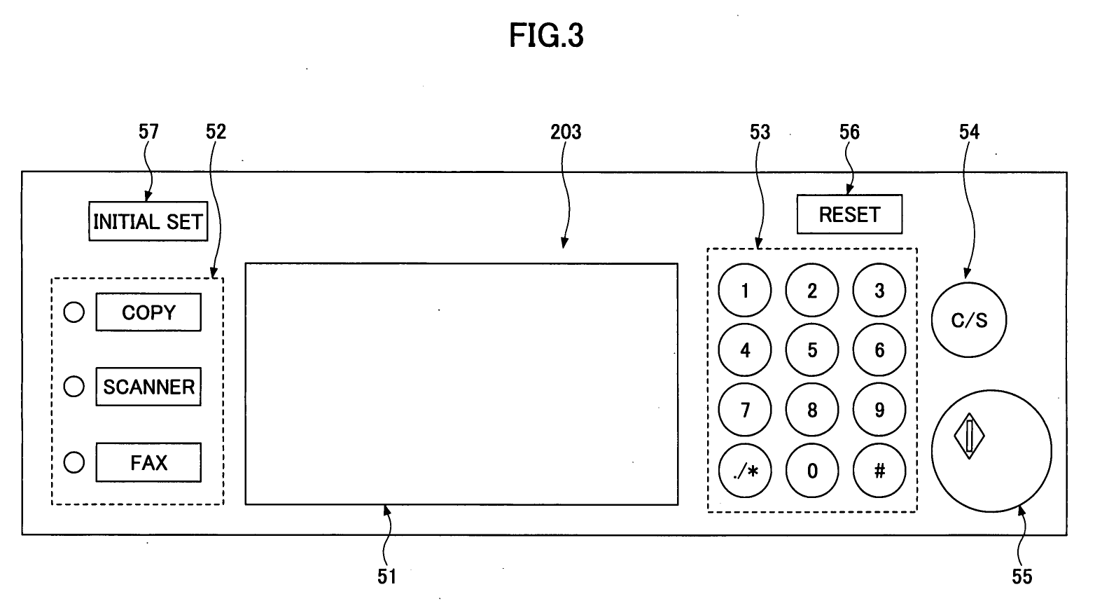

FIG. 3 shows a configuration diagram in one example of the operating part. In the operating part 203, a liquid crystal touch panel 51 for displaying information of the copier, an application switching key 52, a ten-key group 53 for inputting a value, a number of copies, or such, a clear/stop key 54, a start key 55 for starting a job of the application, a mode reset key 56, and an initial set key 57 for carrying out backing up/restoration operation.

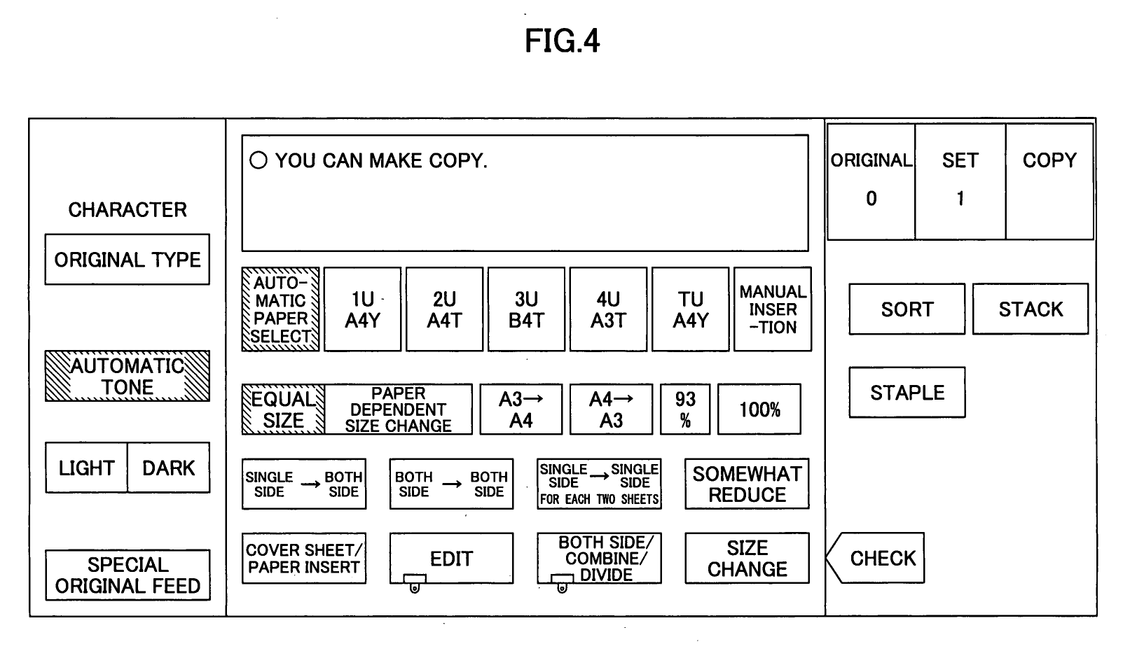

FIG. 4 shows a page image diagram in one example displayed on the liquid crystal touch panel. For example, when a copy application is selected, the page image shown in FIG. 4 is displayed on the liquid crystal touch panel 51. A user may press a button on the page displayed on the liquid crystal touch panel 51, and thus may carry out various sorts of setting concerning the copy application, for example.

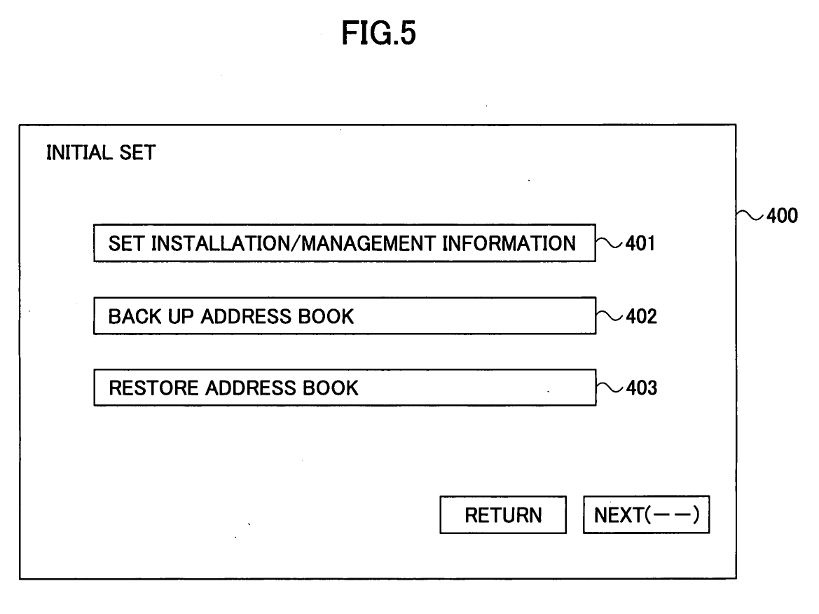

When the initial set key 57 on the operating part 203 is pressed, an initial setting page 400 is displayed on the liquid crystal touch panel 51. FIG. 5 shows a page image diagram in one example of the initial setting page 400 displayed on the liquid crystal touch panel 51 when the initial set key is pressed.

On the initial setting page 400, buttons 401 through 403 for various sorts of setting or executing operation are displayed. When the user presses any one of these buttons 401 through 403, any one of pages described later is then displayed, corresponding to the pressed one of the buttons 401 through 403. The user may carry out execution of a function, various sorts of setting, or check operation, onto the page displayed on the liquid crystal touch panel 51.

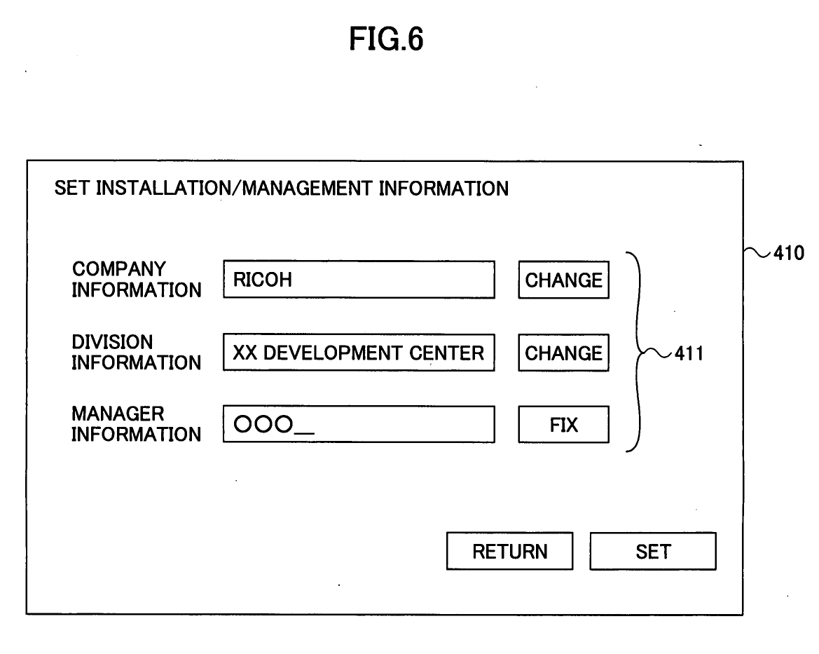

When the button 401 on the initial setting page 400 is pressed, an installation/management information setting page 410 of FIG. 6 is displayed on the liquid crystal touch panel 51. FIG. 6 shows a page image diagram in one example of the installation/management information setting page 410. The installation/management information setting page 410 is a page for a user to set user information in the copier.

When a change button 411 is pressed on the installation/management information setting page 410, a soft keyboard, with which Japanese language characters or alphanumeric characters may be input, is displayed on the liquid crystal touch panel 51. With the use of the soft keyboard, the user may input, as items of the user information, company information, division information, manager information or such. When the soft keyboard is closed, the user information thus input with the use of the soft keyboard is displayed in an input frame of the installation/management information setting page 410.

After thus inputting the necessary items of user information, upon a set button in the installation/management information setting page 410 being pressed, the input user data is stored, for example, in the NV-RAM 302. When a return button is pressed, the input user information is deleted.

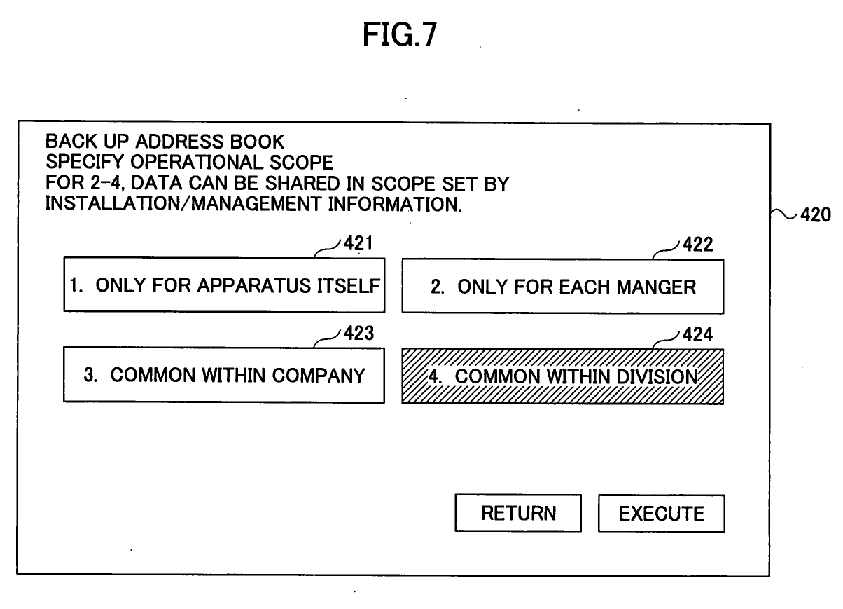

When a button 402 is pressed on the initial setting page 400, an address book backing up page 420 shown in FIG. 7 is displayed on the liquid crystal touch panel 51. FIG. 7 shows a page image diagram in one example of the address book backing up page 420. The address book backing up page 420 is a page for a user to designate an operational scope of an address book, and provide an instruction to back up the address book. It is noted that, throughout the specification and claims, ‘to back up’ means ‘to make a backup of’.

From the address backing up page 420, the user allows to designate, as the operational scope of the address book, one from among a scope only for the apparatus itself, a scope only for each manager, a scope common within the company and a scope common within a division. A button 421 is used for designating the operational scope of the address book as the scope only for the apparatus itself. A button 422 is used for designating the operational scope of the address book as the scope only for each manager. A button 423 is used for designating the operational scope of the address book as the scope common within the company. A button 424 is used for designating the operational scope of the address book as the scope common within a division.

When the operational scope of the address book is thus designated as any one of the scope only for each manager, the scope common within the company and the scope within a division, the operational scope of the address book is determined according to the manager information, company information, or the division information set from the installation/management information setting page 410. When the user selects any one of the buttons 421 through 424, and presses an execute button of the address book backing up page 420, the copier starts address book backing up processing.

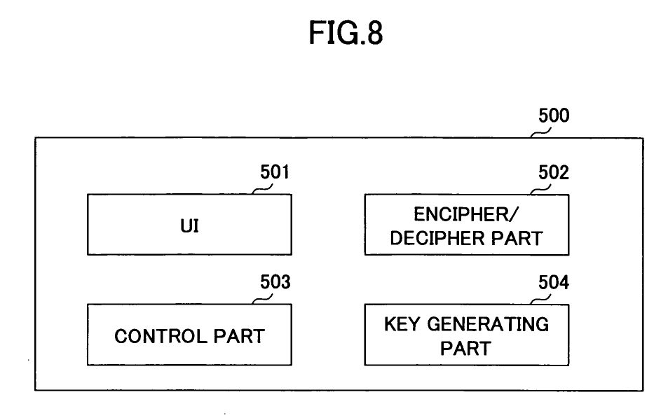

The address book backing up processing is carried out by the enciphering program 500 of FIG. 8. FIG. 8 shows a configuration in one example of the enciphering program. The enciphering program 500 is configured to include modules carrying out respective functions of an UI 501, an enciphering/deciphering part 502, a control part 503 and a key generating part-504. When the enciphering program is executed, the MPU 301 starts up the UI 501, the enciphering/deciphering part 502, the control part 503 and the key generating part 504.

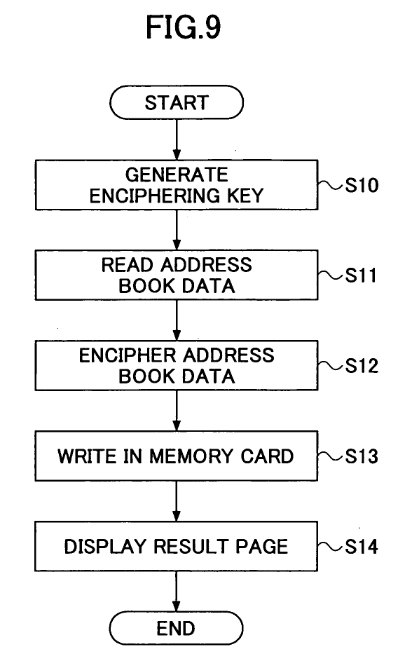

FIG. 9 shows a flow chart in one example of the address book backing up processing. In Step S10, the control part 503 generates an enciphering key with the use of the key generation part 504. Generation of the enciphering key may be carried out as follows: That is, as a seed for generating the enciphering key, the company information, the division information and manager information stored in the NV-RAM 302, and the manufacturer name, the model name and the serial number stored in the NV-RAM 302 or the ROM 303, may be used.

The company information, the division information and the manager information is information which the user can change. For example, the user may change it from the installation/management information setting page 410. The manufacturer name, the model name and the serial number is information which the user cannot change. The manufacturer name is information uniquely identifying the manufacturer. The model name is information uniquely identifying the model of the copier. The serial number is information which is set when the copier is shipped, and is unique to each particular product.

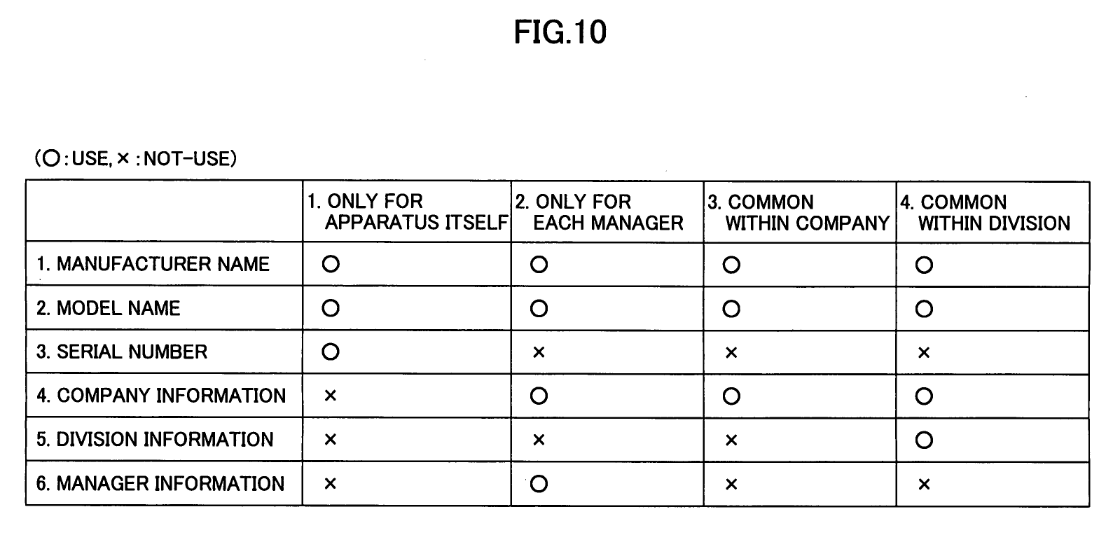

The enciphering program generates the enciphering key with a combination of at least one of the manufacturer name, the model name, the serial number, the company information, the division information and the manager information, as a seed. The seed for generating the enciphering key may be set for each operational scope of the address book, as shown in FIG. 10, for example.

FIG. 10 shows a configuration of one example of a seed set for each operational scope of the address book. In the example of FIG. 10, for each of the operational scopes, i.e., the scope only for the apparatus itself, the scope only for each manager, the scope common within the company and the scope common within a division, a seed of a combination of at least one of the manufacturer name, the model name, the serial number, the company information, the division information and the manager information is set.

For example, for a case where the operational scope of the address book is the scope only for the apparatus itself, the seed is a combination of the manufacturer name, the model name and the serial number as shown in FIG. 10. In the same manner, for a case where the operational scope is the scope common within a division, the seed is a combination of the manufacturer name, the model name, the company information and the division information as shown in FIG. 10.

The key generating part 504 reads out, according to the specific operational scope of the address book selected by means of the buttons 421 through 424 of the address book backing up page 420, a combination of at least one of the manufacturer name, the model name, the serial number, the company information, the division information and the manufacturer information, from the NV-RAM 302 or the ROM 303. Thus, the seed for generating the enciphering key is obtained.

The key generating part 504 joins the combination of at least one of the manufacturer name, the model name, the serial number, the company information, the division information and the manufacturer information, thus read out, together. After that, the key generating part 504 obtains a reduced data (hash value) with the use of a digest generating algorithm such as SHA1, MD5 or such.

Then, the key generating part 504 generates the enciphering key in a length required for enciphering and deciphering information, from the thus-obtained hash value. The enciphering key thus generated employs both the information which the user cannot change and the information which the user can change. Accordingly, analogizing of the enciphering key may not easily be achieved.

Returning to FIG. 9, description of the address book backing up processing is continued. In Step S11 subsequent to Step S10, the control part 503 reads out data of the address book to back up from the HDD 204. In Step S12, the control part 503 then applies the enciphering/deciphering part 502 for enciphering the thus-obtained data of the address book. Specifically, the enciphering/deciphering part 502 enciphers the data of the address book with the use of the enciphering key generated in Step S10.

Then, in Step S13, the control part 503 writes the thus-enciphered address book data in the memory card 221 as backup data. Then, in Step S14, the control part 503 applies the UI 501 for displaying a result page indicating a result of the address book backing up processing on the liquid crystal touch panel 51.

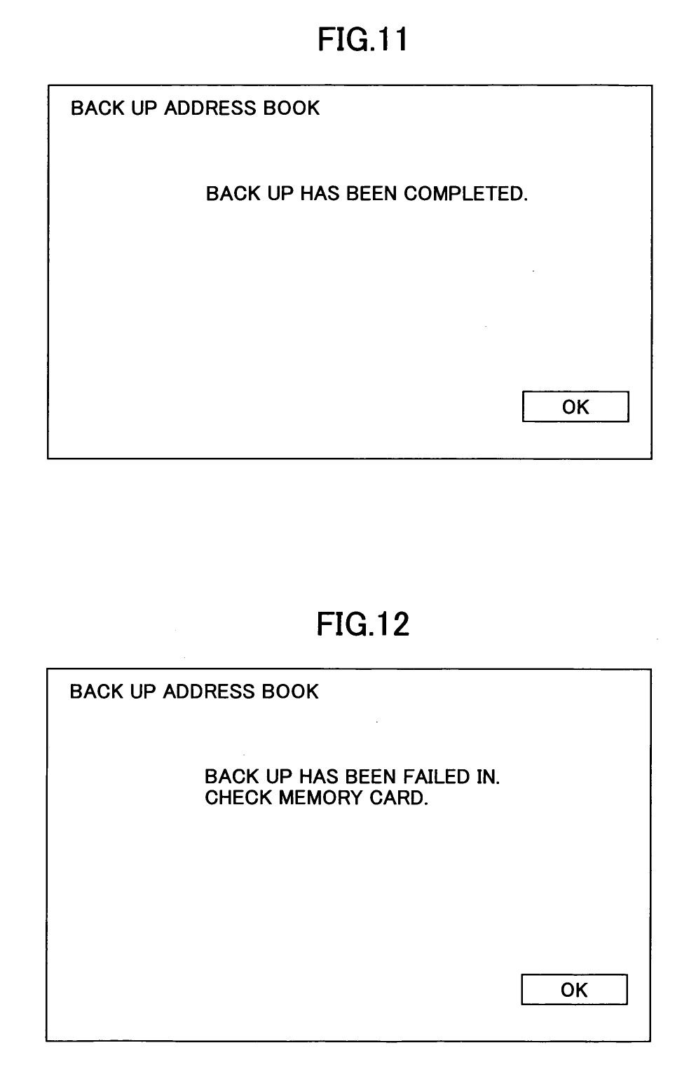

FIG. 11 shows a page image in one example indicating one example of a result page displayed when the address book backing up processing normally ends. FIG. 12 shows a page image in one example indicating one example of a result page displayed when the address book backing up processing ends in failure.

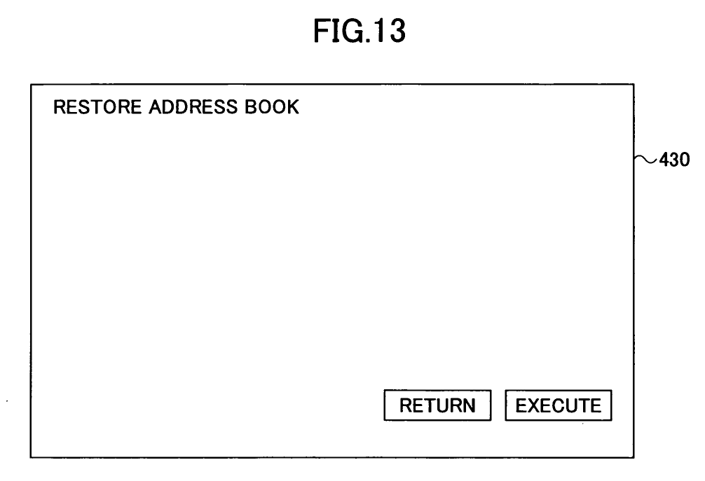

When a button 403 of the initial setting page 400 is pressed, an address book restoration page 430 of FIG. 13 is displayed on the liquid crystal touch panel 54. FIG. 13 shows a page image in example of the address book restoration page 430. The address book restoration page 430 is a page for receiving an instruction from a user for an address book restoration. When an execute button of the address book restoration page 430 is pressed by the user, the copier starts address book restoration processing. It is noted that the address book restoration processing is carried out by the enciphering program 500 of FIG. 8.

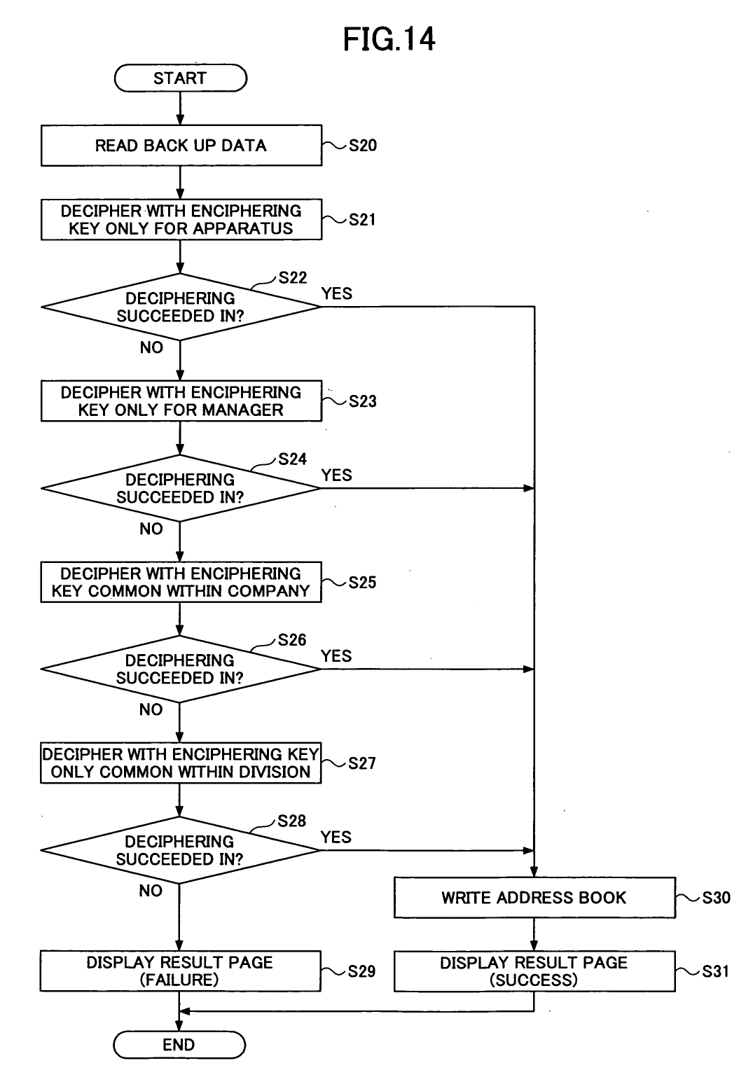

FIG. 14 shows a flow chart of one example of the address book restoration processing. In Step S20, the control part 503 reads the backup data from the memory card 221. Then, in Step S21, the control part 503 applies the key generating part 504 for deciphering the backup data with the use of an enciphering key, generated for a case where an operational scope of an address book is set only for the apparatus itself.

In Step S22, the control part 503 determines whether or not the deciphering of the backup data has been succeeded in. The determination as to whether or not the deciphering of the backup data has been succeeded in can be carried out, by a search of the thus-obtained data for a text which should be necessarily included in the backup data, i.e., for example, the manufacturer name, the model name or such.

When the deciphering has not been succeeded in (No in Step S22), the control part 503 applies the key generation part for deciphering the backup data with the use of the enciphering key, generated for a case where an operational scope of an address book is set only for each manager, in Step S23.

In Step S24, the control part 503 determines whether or not the deciphering of the backup data has been succeeded in. When the deciphering has not been succeeded in (No in Step S24), the control part 503 applies the key generation part for deciphering the backup data with the use of the enciphering key, generated for a case where an operational scope of an address book is set common within the company, in Step S25.

In Step S26, the control part 503 determines whether or not the deciphering of the backup data has been succeeded in. When the deciphering has not been succeeded in (No in Step S26), the control part 503 applies the key generation part for deciphering the backup data with the use of the enciphering key, generated for a case where an operational scope of an address book is set common within a division, in Step S27.

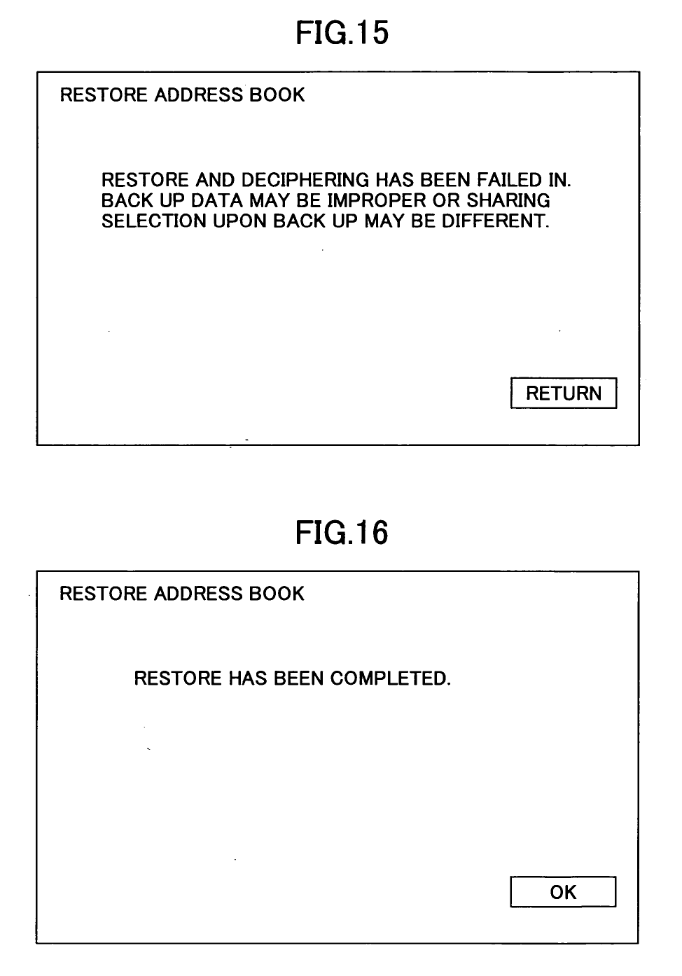

In Step S28, the control part 503 determines whether or not the deciphering of the backup data has been succeeded in. When the deciphering has not been succeeded in (No in Step S27), the control part 503 uses the UI 501 for displaying a result page of FIG. 15 indicating that the address book restoration processing is failed in, in Step S29.

On the other hand, when the deciphering has been succeeded in (Yes in any of Steps S22, S24, S26 and S28), the control part 503 writes the thus-obtained deciphered backup data in the HDD 204, in Step S30. It is noted that the operational scope of the address book, thus written in the HDD 204 in Step S30, may be set to correspond to the enciphering key, with which the deciphering of the backup data was thus succeeded in. Then, in Step S31, the control part 503 uses the UI 501 for displaying a result page of FIG. 16 indicating that the address book restoration processing has been succeeded in, on the liquid crystal touch panel 51.

In the address book restoration processing in FIG. 14, the address book can be restored from the backup data when the seed (generation condition) of the enciphering key, applied when the address book was originally backed up, coincides with the seed (generation condition) of the enciphering key, of the copier which restores the address book. That is, as will be described below, each copier may have different information from which a seed for generating an enciphering key is generated according to FIG. 10. Accordingly, the respective enciphering keys generated for Steps S21, S23, S25 and S27 of FIG. 14 in each copier may be different among respective copiers. As a result, which enciphering key (i.e., in which one of Steps S21, S23, S25 and S27) can actually decipher given address book backup data and restore original address book therefrom in each copier may depend on each particular copier of the respective copiers.

For example, when an address book is backed with a designation of the operational scope thereof only for the apparatus itself, the seed of the enciphering key includes information unique to the apparatus itself, which the user cannot change (see FIG. 10). Accordingly, in this case, restoration of the same address book in another apparatus is difficult.

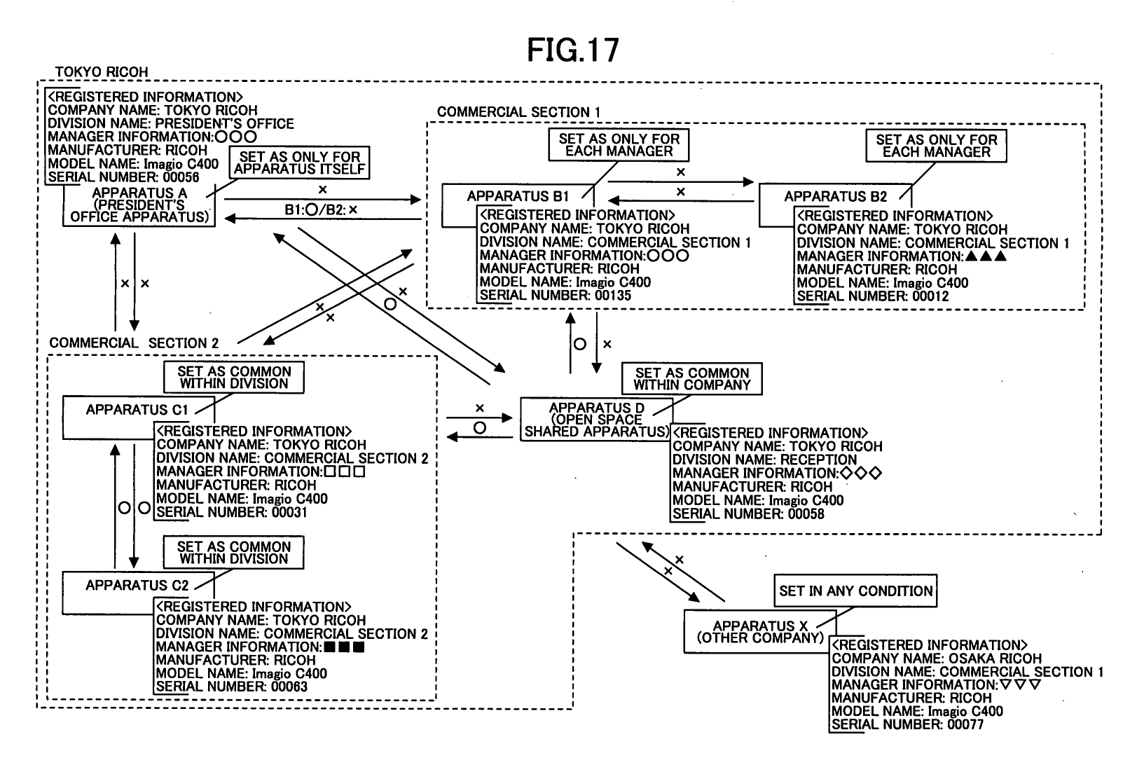

FIG. 17 shows a schematic diagram illustrating a relationship between the operational scope of the address book to back up and apparatuses in which restoration of the same can be carried out. Each arrow in FIG. 17 extends from an apparatus which carried out backing up of the address book to an apparatus which can carry out restoration of the same. The arrow represents that the restoration can be carried out, by a symbol ◯, while represents that the restoration cannot be carried out, by a symbol X.

When the operational scope of an address book is only for an apparatus itself as in an apparatus A, the address book information backed up in the apparatus A cannot be restored in any apparatus other then the apparatus A. This is because, when the operational scope of the address book is only for the apparatus itself, the seed is made of the combination of the manufacturer name, the model name and the serial number (see FIG. 10). The serial number is information unique to the particular product of the apparatus, and as a result, the enciphering keys generated therefrom are necessarily different among the respective products.

When the operational scope of the address book is only for each manager as in an apparatus B1, address information backed up in the apparatus B1 can be restored in an apparatus A, but cannot be restored in any apparatus other than the apparatuses A and B1. This is because, when the operational scope of the address book is only for each manager, the seed is made of the combination of the manufacturer name, the model name, the company information and the manager information (see FIG. 10).

For example, the apparatus A and the apparatus B1 are common in the manufacturer name, the model name, the company information and the manager information (see FIG. 17). Accordingly, these apparatuses have the identical enciphering keys. On the other hand, the manager information is different between the apparatus B1 and any apparatus other than the apparatuses B1 and A, and thus, these apparatuses have the different enciphering keys.

When the operational scope of the address book is within the company as in an apparatus D, address information backed up in the apparatus D can be restored in any of the apparatuses A, B1, B2, C1, C2 and D, but cannot be restored in an apparatus X. This is because, when the operational scope of the address book is set within the company, the seed is made of the combination of the manufacturer name, the model name and the company information.

The apparatuses A, B1, B2, C1, C2 and D are common in the manufacturer name, the model name and the company information. Accordingly, these apparatuses have the identical enciphering keys. On the other hand, the company information (company name) is different between the apparatus X and the apparatus D, and thus, these apparatuses have the different enciphering keys.

When the operational scope of the address book is within a division as in the apparatus C1, address information backed up in the apparatus C1 can be restored in any of apparatuses C1 and C2, but cannot be restored in any apparatuses other than the apparatuses C1 and C2. This is because, when the operational scope of the address book is within the division, the seed is made of the combination of the manufacturer name, the model name, the company information and the division information.

The apparatuses C1 and C2 are common in the manufacturer name, the model name, the company information and the division information. Accordingly, these apparatuses have the identical enciphering keys. On the other hand, the division information (division names) is different between the apparatuses C1/C2 and the apparatuses other than those C1/C2, and thus, they have the different enciphering keys.

Thus, in a copier according to the present invention, both previously set information unique to the apparatus, which a user cannot change, and information which the user can change, are used as a seed. Accordingly, analogizing of the enciphering key is very difficult. As a result, a security strength of the address book backup data can be increased. Further, since the copier according to the present invention applies the previously set information as a seed for an enciphering key, generation of the enciphering key becomes easier. As a result, for the copier according to the present invention, management of enciphering keys is not required.

According to a copier in the present invention, the operational scope of the address book is designated, and, then, a combination of at least one information, previously set in the copier, can be utilized to correspond to the thus-designated operational scope. As a result, the user becomes free from especially setting a seed for an enciphering key.

Further, according to a copier in the present invention, a combination of at least one information previously set in the copier can be utilized as a seed for an enciphering key. As a result, a variation of an operational scope, in which address book backup information can be shared, can be made to correspond to an actual user's environment/organization. Further, according to the copier in the present invention, the operational scope in which the address book backup data can be shared can be positively shown to the user while the seed for the enciphering key is hidden, for example, through Steps S21 through S28 of FIG. 14.

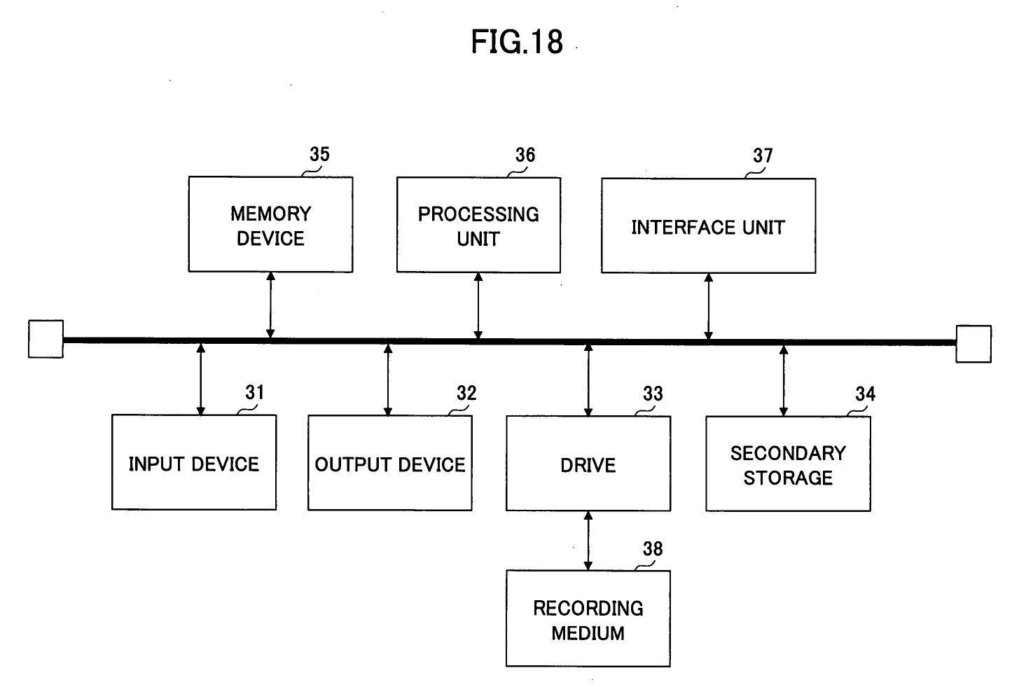

The enciphering program 500 according to the present invention may also be executed by a personal computer (PC). The above-mentioned enciphered/deciphered information may not be only address book information, but also, document information, image information or such. FIG. 18 shows a configuration diagram of a personal computer (PC) in one embodiment of the present invention.

FIG. 18 shows a configuration of the example of the PC. The PC in FIG. 18 includes an input device 31, an output device 32, a drive 33, a secondary storage 34, a memory device 35, a processing unit 36 and an interface unit 37.

The input device 31 includes a keyboard, a mouse and so forth, and is used for inputting various sorts of signals. The output device 32 includes a display device or such, and is used for displaying various sorts of windows, data and so forth. The interface unit 37 includes a modem, a LAN card and so forth, and is used for connecting with a communication network.

The enciphering program 500 according to the present invention is at least a part of various sorts of programs prepared for controlling the PC. The enciphering program 500 may be loaded as a result of it being dispatched via a recording medium 38, or downloaded via the communication network, in the PC.

As the recording medium 38 to store the enciphering program 500 for the purpose of dispatching, various types of recording media may be applied, for example, recording media optically, electrically or magnetically storing information, such as a CD-ROM, a flexible disk, a magneto-optical disk and so forth; and semiconductor memories electrically storing information such as a ROM, a flash memory, and so forth.

When the recording medium 38 storing the enciphering program 500 is set in the drive 33, the enciphering program 500 is installed in the secondary storage 34 via the drive 33. The enciphering program 500 downloaded via the communication network is installed in the secondary storage 34 via the interface unit 37. The PC stores the enciphering program 500 thus installed, and also, stores the necessary files, data and so forth.

The memory device 35 stores the enciphering program 500 read out from the secondary storage 34 upon starting up of the PC. Then, the processing unit 36 carries out various sorts of processing according to the enciphering program 500, described above, stored in the memory device 35.

The present invention is not limited to the embodiments specifically described above, and variations and modifications may be made without departing from the basic concept of the present invention claimed below. In the embodiments described above, the enciphering program 500 executes all the processing shown in FIGS. 9 and 14, as one example. However, a configuration may be made such that the processing other than the enciphering and deciphering processing may be carried out by another program.

The present application is based on Japanese Priority Applications Nos. 2005-041100 and 2006-030290, filed on Feb. 17, 2005 and Feb. 7, 2006, respectively, the entire contents of which are hereby incorporated herein by reference.

What is claimed is:

1. An electronic apparatus for managing first information sharable by a plurality of users, comprising:
an enciphering/deciphering part generating a key for enciphering and deciphering the first information for each of operational scopes of the first information, with at least one combination of second information previously set in the own apparatus as a seed, and enciphering and deciphering the first information with said key.

2. The electronic apparatus as claimed in claim 1, wherein:
said enciphering/deciphering part allows a user to specify the operational scope of the first information, and enciphers the first information with the use of said key corresponding to said operational scope; and
when deciphering the thus-enciphered first information, said part tries deciphering with the key corresponding to each of the operational scopes of the first information in sequence, and sets the operational scope of the first information for which the deciphering is thus succeeded in, for the key with which the deciphering is thus succeeded in.

3. The electronic apparatus as claimed in claim 1, wherein:
said enciphering/deciphering part generates the key with a combination of information, unique to the apparatus, which the user cannot change, and information, which the user can change, as a seed.

4. The electronic apparatus as claimed in claim 3, wherein:
said information, unique to the apparatus, which the user cannot change, comprises information concerning a manufacturer or a selling agency of said electronic apparatus and information uniquely identifying the apparatus.

5. The electronic apparatus as claimed in claim 4, wherein:
said information, unique to the apparatus, which the user cannot change, comprises a manufacturer name, a model name and a serial number.

6. The electronic apparatus as claimed in claim 3, wherein:
said information which the user can change comprises company information, division information and manager information.

7. The electronic apparatus as claimed in claim 1, wherein:
the operational scope of the first information comprises a scope only for the apparatus itself, a scope only for each manager, a scope common within a company, and a scope common within a division.

8. The electronic apparatus as claimed in claim 1, wherein:
the first information comprises address-book information.

9. The electronic apparatus as claimed in claim 1, wherein:
said enciphering/deciphering part allows a user to specify the operational scope of the first information, enciphers the first information with the key corresponding to said operational scope of the first information, and backs up the first information; and
deciphers with the key corresponding to the operational scope of the first information, and restores the first information in the electronic apparatus belonging to the operational scope.

10. An information managing method for managing first information sharable by a plurality of users, comprising:
a key generating step of generating a key for enciphering and deciphering the first information for each of operational scopes of the first information, with at least one combination of second information previously set in the own apparatus as a seed; and
an enciphering/deciphering step of enciphering and deciphering the first information with said key.

11. The information managing method as claimed in claim 10, wherein:
said enciphering/deciphering step comprises an enciphering step of allowing a user to specify the operational scope of the first information, and enciphering the first information with the use of said key corresponding to said operational scope; and
a deciphering step of deciphering the thus-enciphered first information, by trying to decipher with the key corresponding to each of the operational scopes of the first information in sequence; and setting the operational scope of the first information for which the deciphering is thus succeeded in, for the key with which the deciphering is thus succeeded in.

12. The information managing method as claimed in claim 10, wherein:
said enciphering/deciphering step generating the key with a combination of information, unique to the apparatus, which the user cannot change, and information, which the user can change, as a seed.

13. The information managing method as claimed in claim 12, wherein:
said information, unique to the apparatus, which the user cannot change, comprises information concerning a manufacturer or a selling agency of said electronic apparatus and information uniquely identifying the apparatus.

14. The information managing method as claimed in claim 13, wherein:
said information, unique to the apparatus, which the user cannot change, comprises a manufacturer name, a model name and a serial number.

15. The information managing method as claimed in claim 12, wherein:
said information which the user can change comprises company information, division information and manager information.

16. The information managing method as claimed in claim 10, wherein;
the operational scope of the first information comprises a scope only for the apparatus itself, a scope only for each manager, a scope common within a company, and a scope common within a division.

17. The information managing method as claimed in claim 10, wherein:
the first information comprises address-book information.

18. The information managing method as claimed in claim 10, wherein:
said enciphering/deciphering step comprises:
a backing up step of allowing a user to specify the operational scope of the first information, enciphering the first information with the key corresponding to said operational scope of the first information, and backing up the first information;
a restoring step of deciphering with the key corresponding to the operational scope of the first information, and restoring the first information in the electronic apparatus belonging to the operational scope.

19. An information managing program executed by an electronic apparatus, configured to comprise a storage and a processing unit, which manages first information sharable by a plurality of users, wherein:
said storage stores the first information and second information previously set in said electronic apparatus; and
said processing unit executes:
a key generating step of generating a key for enciphering and deciphering the first information for each of operational scopes of the first information, with at least one combination of second information previously set in the own apparatus as a seed; and
an enciphering/deciphering step of enciphering and deciphering the first information with said key.

20. The information managing program as claimed in claim 19, wherein:
said enciphering/deciphering step comprises an enciphering step of allowing a user to specify the operational scope of the first information, and enciphering the first information with the use of said key corresponding to said operational scope;
a deciphering step of deciphering the thus-enciphered first information, by trying to decipher with the key corresponding to each of the operational scopes of the first information in sequence; and setting the operational scope of the first information for which the deciphering is thus succeeded in, for the key with which the deciphering is thus succeeded in.

21. A computer readable information recording medium storing the information managing program claimed in claim 19.

22. A computer readable information recording medium storing the information managing program claimed in claim 20.
